(19) United States
(12) Patent Application Publication
(10) Pub. No.: US 2026/0294118 A1
(43) Pub. Date: Oct. 1, 2026

(54) MUSICAL SEAT BODY AND SOFA THEREOF

(71) Applicant: MAN WAH INDUSTRIAL COMPANY LIMITED, Hong Kong (CN)

(72) Inventor: Kui CHEN, Hong Kong (CN)

(73) Assignee: MAN WAH INDUSTRIAL COMPANY LIMITED, Hong Kong (CN)

(21) Appl. No.: 19/173,777

(22) Filed: Apr. 8, 2025

Related U.S. Application Data
(63) Continuation of application No. PCT/CN2025/087174, filed on Apr. 3, 2025.

(30) Foreign Application Priority Data
Mar. 26, 2025 (CN) 202510366662.9
Mar. 26, 2025 (CN) 202520549509.5

(51) Int. Cl. A47C 7/72; A47C 7/38; A47C 17/04; A47C 31/11; A61H 23/00; G06F 3/16

(52) U.S. Cl. CPC A47C 7/727; A47C 7/383; A47C 17/04; A47C 31/11; A61H 23/00; A61H 2201/0149; A61H 2201/5007; A61H 2205/081; A61H 2205/088; G06F 3/162

(57) ABSTRACT

A sofa, including a musical seat body, the musical seat body including a sofa seat, a backrest, and a headrest. The headrest includes a central member and two side connecting members, the central member is connected to the backrest, the two side connecting members are hinged to two opposite sides of the central member, each side connecting member is directly or indirectly provided with an audio device, and the side connecting members drive the audio devices to rotate relative to the central member to move the audio devices close to or away from a seated user's ears. The headrest has an initial expanded state and a rotationally folded state, when in the initial expanded state, the side connecting members and the central member are relatively expanded to cause the headrest to be a flat-spread shape and position the audio devices away from the seated user's ears.

### CROSS REFERENCE TO RELATED APPLICATIONS

This application is a continuation application of PCT application No. PCT/CN 2025/087174 filed on Apr. 3, 2025, which is based upon and claims priority to Chinese Patent Application No. 202520549509.5 filed on Mar. 26, 2025 and Chinese Patent Application No. 202510366662.9 filed on Mar. 26, 2025, the entire content of which are incorporated herein by reference for all purposes.

### TECHNICAL FIELD

The present disclosure relates to the technical field of furniture, and in particular, to a sofa.

### BACKGROUND

To enhance the seating experience of sofas, many sofas are equipped with audio devices. For example, a multifunctional electric sofa may have audio devices installed on both sides of the headrest of the electric sofa body. While a seated user can relax their body by lying on the sofa, the music played through the audio devices can further enhance the user's relaxation. However, because the audio devices are fixed to the electric sofa body and project sound forward, they lack privacy and immersive quality. This setup may also disturb others nearby who are listening to different music or engaged in conversation.

### SUMMARY

According to a first aspect of the present disclosure, there is provided a sofa including at least one musical seat body, the musical seat body including a sofa seat, a backrest, and a headrest, and the backrest is connected to the sofa seat. The headrest includes a central member and two side connecting members, the central member is connected to the backrest, the two side connecting members are hinged to two opposite sides of the central member, each side connecting member is directly or indirectly provided with an audio device, and the side connecting members drive the audio devices to rotate relative to the central member to move the audio devices close to or away from a seated user's ears. The headrest has an initial expanded state and a rotationally folded state, in the initial expanded state, the side connecting members and the central member are relatively expanded to cause the headrest to be a flat-spread shape and to position the audio devices away from the seated user's ears; and in the rotationally folded state, and the side connecting members drive the audio devices to rotate inward relative to the central member to position the audio devices closer to the seated user's ears.

According to a second aspect of the present disclosure, there is provided a musical seat body including a sofa seat, a backrest, and a headrest. The backrest is connected to the sofa seat, the headrest includes a central member and two side connecting members, the central member is connected to the backrest, the two side connecting members are hinged to two opposite sides of the central member, each side connecting member is directly or indirectly provided with an audio device, and the side connecting members drive the audio devices to rotate relative to the central member to move the audio devices close to or away from a seated user's ears. The headrest has an initial expanded state and a rotationally folded state. In the initial expanded state, the side connecting members and the central member are relatively expanded to cause the headrest to be a flat-spread shape and to position the audio devices away from the seated user's ears; and in the rotationally folded state, the side connecting members drive the audio devices to rotate inward relative to the central member to position the audio devices closer to the seated user's ears.

### BRIEF DESCRIPTION OF THE DRAWINGS

FIG. 1 is a schematic structural diagram of a sofa according to some examples of the present disclosure.

FIG. 2 is a schematic structural diagram showing installation positions of audio devices and two vibrators according to some examples of the present disclosure.

FIG. 3 is an exploded schematic diagram of a headrest and a back frame according to some examples of the present disclosure.

FIG. 4 is a schematic structural diagram of the connection between a central member and side connecting members according to some examples of the present disclosure.

FIG. 5 is a schematic structural diagram showing rear fabric of a back cover in an opened state according to some examples of the present disclosure.

FIG. 6 is an exploded schematic diagram of the structure shown in FIG. 5.

FIG. 7 is a cross-sectional schematic diagram of a first installation structure of the audio device in the headrest according to some examples of the present disclosure.

FIG. 8 is a cross-sectional schematic diagram of a second installation structure of the audio device in the headrest according to some examples of the present disclosure.

FIG. 9 is a schematic structural diagram of a corner sofa in a single-control-panel mode according to some examples of the present disclosure.

FIG. 10 is a schematic structural diagram of a corner sofa in a dual-control-panel mode according to some examples of the present disclosure.

FIG. 11 is a schematic diagram of an interface structure of a Y-shaped connecting cable according to some examples of the present disclosure.

FIG. 12 is a schematic wiring diagram of the Y-shaped connecting cable according to some examples of the present disclosure.

FIG. 13 is a schematic principal diagram of the dual-control-panel mode according to some examples of the present disclosure.

FIG. 14 is a schematic principal diagram of the single-control-panel mode according to some examples of the present disclosure.

### DETAILED DESCRIPTION

For a better understanding and implementation, the technical solutions in the embodiments of the present disclosure are clearly and completely described below in conjunction with the attached drawings of the present disclosure.

In the description of the present disclosure, it is to be noted that the terms “up,” “down,” “front,” “back,” “left,” “right,” “vertical,” “horizontal,” “top,” “bottom,” “inside,” “outside” and other orientation or position relationships are based on the orientation or position relationships shown in the attached drawings. It is only intended to facilitate description of the present disclosure and simplify description, but not to indicate or imply that the referred device or element has a specific orientation, or is constructed and operated in a specific orientation. Therefore, they should not be construed as a limitation of the present disclosure.

Unless otherwise defined, all terms including technical and scientific terms used herein have the same meaning as commonly understood by those skilled in the art to which the present disclosure belongs. The terms used herein in the specification of the present disclosure are used only to describe specific embodiments and are not intended as a limitation of the disclosure.

The meanings of the reference numerals are as follows.

100 musical seat body; 1 sofa seat; 11 seat cushion; 12 support spring; 2 backrest; 21 back frame; 22 back cushion; 23 back cover; 231 main fabric; 232 rear fabric; 233 clamping strip; 24 horizontal plate; 241 through hole; 3 headrest; 31 central member; 311 stud; 312 nut; 32 side connecting member; 321 wiring hole; 33 pillow cushion; 331 first cushion; 332 second cushion; 333 accommodation groove; 34 pillow cover; 35 hinge; 351 rotating arm; 3511 bent portion; 352 rotating shaft; 353 gear adjustment mechanism; 36 avoidance groove; 37 connection groove; 4 audio device; 41 first limiting member; 42 second limiting member; 5 first vibrator; 6 second vibrator; 200 armrest; 300 tea table; 400 corner seat body; 500 control panel; 501 first function button; 502 second function button; 600 Y-shaped connecting cable; 700 control center.

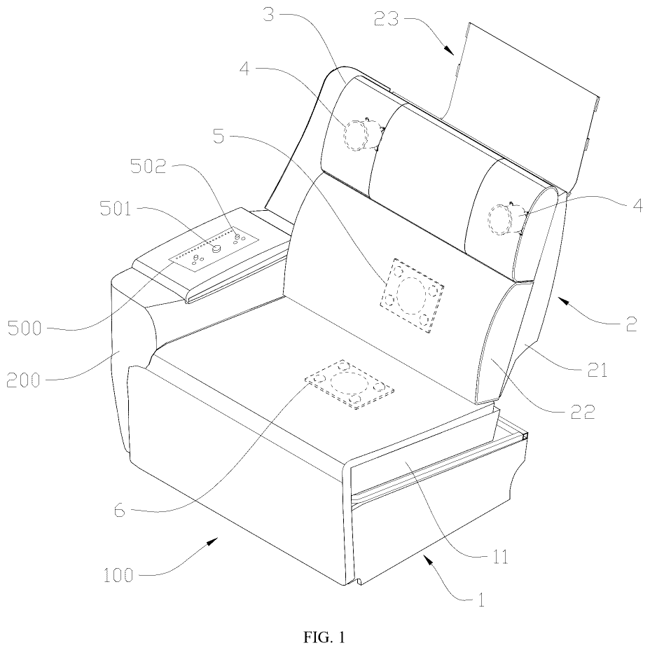

Referring to FIG. 1, the present disclosure provides a sofa with an immersive music playback function. The sofa may be a single-seat sofa, a dual-seat sofa, a multi-seat sofa, or a corner sofa. Taking a side-positioned seat in a multi-seat sofa or corner sofa as an example, the sofa may include: a musical seat body 100, an armrest 200, at least one control panel 500, and at least one control center 700. The musical seat body 100 may include a sofa seat 1, a backrest 2, a headrest 3, an audio device 4, a first vibrator 5, and a second vibrator 6, in which the main structural body of the sofa includes the sofa seat 1, backrest 2, and headrest 3. The armrest 200 is connected to a side of the sofa seat 1, the backrest 2 is connected to a rear end of the sofa seat 1, and the headrest 3 is connected to an upper end of the backrest 2. The audio device 4 is disposed on the headrest 3. The first vibrator 5 is disposed on the backrest 2 and corresponds to a seated user's back, while the second vibrator 6 is disposed on the sofa seat 1 and corresponds to the seated user's hips. The first vibrator 5 and the second vibrator 6 are configured to provide vibration feedback when the audio device 4 plays music. The audio device 4, first vibrator 5, and second vibrator 6 are electrically connected to one control center 700 and a corresponding control panel 500, in which the electrical connection may be specifically a wired connection or a wireless connection to provide data communication functionality, thereby enabling control or adjustment of the audio device 4, first vibrator 5, and second vibrator 6 via the control panel 500. The first vibrator 5 may be specifically installed on springs of the back frame 21 of the backrest 2 or within the back cushion 22 of the backrest 2. The second vibrator 6 may be specifically installed on the support spring 12 of the sofa seat 1 or within the seat cushion 11 of the sofa seat 1.

The control center 700 may be a chip circuit board structure integrated into a bass speaker cabinet. In such cases, if the sofa is a single-seat sofa, the bass speaker cabinet may be installed inside the armrest 200 or inside the musical seat body 100, and the control panel 500 may be installed on the armrest 200; if the sofa is a dual-seat sofa, multi-seat sofa, or corner sofa, the bass speaker cabinet may alternatively be installed inside one of the musical seat bodies 100 or inside the tea table 300, and the control panel 500 may be installed on the armrest 200 or the tea table 300.

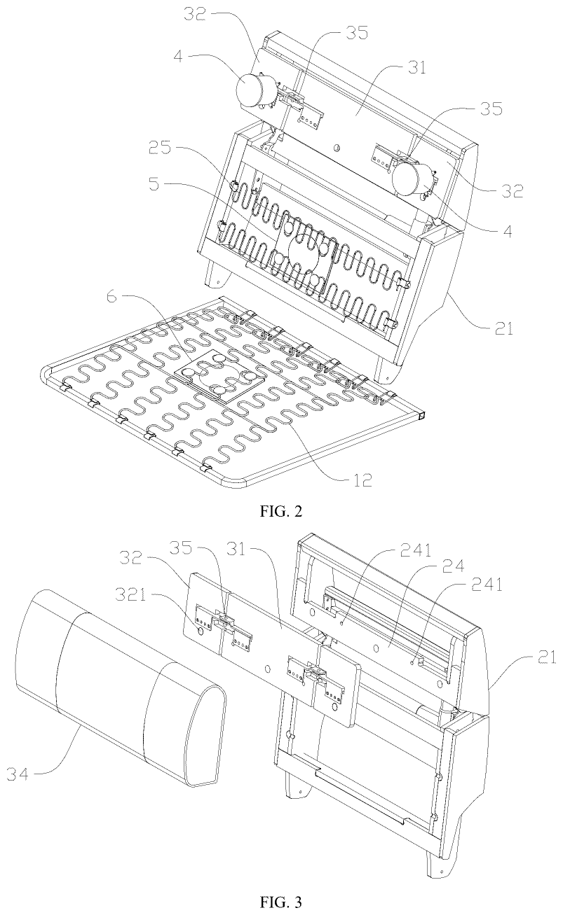

Referring to FIGS. 2 to 4, the headrest 3 includes a central member 31 and two side connecting members 32. The central member 31 and the side connecting members 32 are, in some examples, plate-shaped, and their configurations may be square or other shapes. The central member 31 is connected to the backrest 2, and the two side connecting members 32 are hinged to opposite sides of the central member 31. The two side connecting members 32 may rotate toward or away from the central member 31. Each side connecting member 32 is provided with an audio device 4, which may be directly mounted on the side connecting member 32 or indirectly arranged relative to the side connecting member 32. The side connecting members 32 may drive the audio devices 4 to rotate relative to the central member 31, thereby moving the audio devices 4 closer to or away from a seated user's ears.

In some examples, the central member 31 and the side connecting members 32 are hinged through a hinge 35. The hinge 35 includes two rotating arms 351, a rotating shaft 352, and a gear adjustment mechanism 353. An end of each rotating arm 351 is connected to the rotating shaft 352, and the gear adjustment mechanism 353 is disposed at the rotating shaft 352. The gear adjustment mechanism 353 is configured to adjust a relative angle between the two rotating arms 351 and fix the angle. An opposite end of one rotating arm 351 is fixedly connected to the central member 31, and an opposite end of the other rotating arm 351 is fixedly connected to the side connecting member 32.

The gear adjustment mechanism 353 may adopt any known structure capable of providing multi-position angle adjustment to accommodate different seated users'requirements for rotation angles during immersive music experiences. As a specific example, the gear adjustment mechanism 353 may be a ratchet-type gear adjustment mechanism 353, including a ratchet wheel, a pawl, a pawl bracket, a limiting pin, a first reset torsion spring, and a second reset torsion spring. The rotating shaft 352 is fixedly connected to the first rotating arm 351 and pivotally connected to the second rotating arm 351, wherein the first rotating arm 351 is fixedly connected to the central member 31, and the second rotating arm 351 is fixedly connected to the side connecting member 32. The pawl bracket is disposed on the rotating shaft 352 or the first rotating arm 351, and the ratchet wheel is disposed on the second rotating arm 351. The pawl, which engages with the ratchet wheel, is rotatably arranged on the pawl bracket. A limiting pin is provided on a side of the pawl and cooperates with a limiting hole on the second rotating arm 351 to restrict movement of the pawl. A first reset torsion spring is disposed between the second rotating arm 351 and the pawl bracket, and a second reset torsion spring is disposed between the pawl and the pawl bracket. When the ratchet wheel and the pawl are in their initial positions, the side connecting member 32 and the central member 31 are in a relatively expanded state with the ratchet wheel and pawl engaged. When an external force drives the side connecting member 32 and the second rotating arm 351 to rotate around the rotating shaft 352, the ratchet wheel and pawl cooperate to enable position adjustment. When the external force continues to drive the side connecting member 32 and the second rotating arm 351 until the limiting pin is restricted by the limiting hole, the pawl cannot rotate further. The second rotating arm 351 then drives the pawl to rotate reversely against the force of the second reset torsion spring via the limiting pin, causing the pawl to disengage from the ratchet wheel and thereby achieving unlocking. When the external force is removed, the second rotating arm 351 returns to its initial position under the driving force of the first reset torsion spring, and the pawl also returns to its initial position under the driving force of the second reset torsion spring, re-engaging with the ratchet wheel.

The usage scenarios of sofas impose higher requirements compared to chairs. Therefore, in the sofa of the present disclosure, the headrest 3 has two states: an initial expanded state and a rotationally folded state. In the initial expanded state, the side connecting members 32 and the central member 31 are relatively expanded, causing the headrest 3 to be a flat-spread configuration and positioning the audio devices 4 away from a seated user's ears. When resting on the sofa, the user can freely adjust their posture, such as turning their head for conversation or leaning sideways, without interference from the side connecting members 32, thereby ensuring normal use of the sofa. In the rotationally folded state, the side connecting members 32 drive the audio devices 4 to rotate inward relative to the central member 31. When resting on the sofa, the user's head can lean against the central member 31 of the headrest 3 for physical relaxation, while the audio devices 4 are positioned closer to the user's ears. In this state, music playback provides an immersive experience with enhanced sound quality and privacy.

In the above solution, the combination of the audio device 4 installed on the headrest 3, the first vibrator 5 installed on the backrest 2, and the second vibrator 6 installed on the sofa seat 1 can not only provide an immersive music experience but also add vibrational sensations to the body, delivering a 4D music experience. Specifically, when the audio device 4 plays music, the first vibrator 5 and the second vibrator 6 generate corresponding vibrations based on audio signals, causing the sofa to vibrate synchronously with the audio effects, thereby enhancing the immersion and realism of the audio experience. The first vibrator 5 delivers vibration feedback to the back of a seated user, and the second vibrator 6 provides vibration feedback to the user's hips. It should be understood that either the first vibrator 5 or the second vibrator 6 may be provided independently.

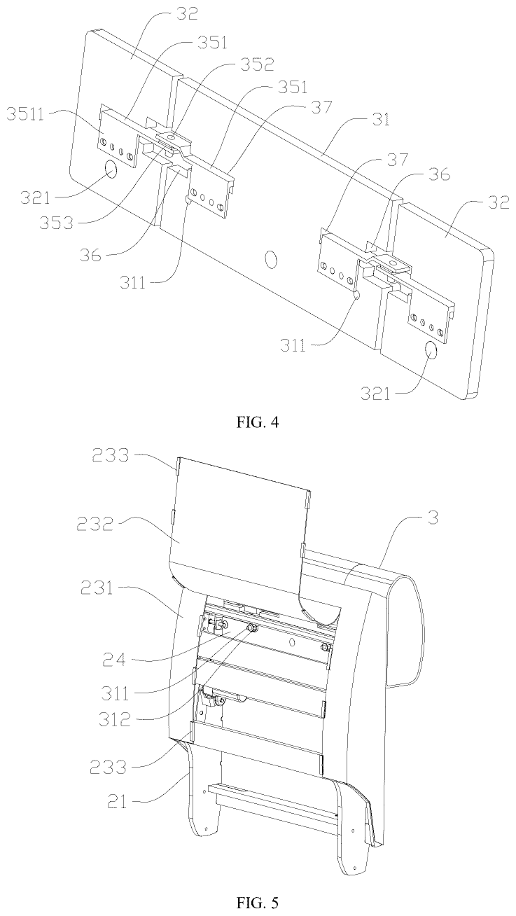

Referring to FIG. 4, the presence of the gear adjustment mechanism 353 may result in a locally relatively large size of the hinge 35. To control the overall thickness of the headrest 3 and the gap size between the central member 31 and the side connecting members 32, in some examples, both the central member 31 and the side connecting members 32 are provided with interconnected avoidance grooves 36 and connection grooves 37. The avoidance grooves 36 correspond to the gear adjustment mechanism 353, and an opposite end of each of the rotating arms 351 is inserted into the connection grooves 37 and fixedly connected. Specifically, the avoidance grooves 36 have a width greater than that of the connection grooves 37, an opposite end of each of the rotating arms 351 is formed with a bent portion 3511, and the bent portion 3511 is secured to the central member 31 or the side connecting member 32 via screws. By providing the avoidance grooves 36, the space at the avoidance grooves 36 is utilized to accommodate the gear adjustment mechanism 353, thereby allowing the gap between the central member 31 and the side connecting members 32 to be relatively small. This eliminates the need to either increase the gap between the central member 31 and the side connecting members 32 to avoid interference with the gear adjustment mechanism 353 or relocate the gear adjustment mechanism 353 rearward for clearance. Consequently, the overall thickness of the headrest 3 and the gap between the central member 31 and the side connecting members 32 can be controlled to relatively small dimensions. In the initial expanded state, this design prevents a sagging sensation at the junction between the central member 31 and the side connecting members 32, thereby providing improved support.

Referring to FIG. 1, the control panel 500 is disposed on the armrest 200. Specifically, a mounting groove may be formed on an upper surface or an inner side surface of the armrest 200, and the control panel 500 is then installed in the mounting groove. In some multi-seat sofas or corner sofas, the control panel 500 may alternatively be disposed on the tea table 300. The control panel 500 is provided with a first function button 501 and a second function button 502. In some examples, the first function button 501 and the second function button 502 adopt a combined rotary-press structure. Rotating the first function button 501 adjusts the volume of the audio device 4, while pressing the first function button 501 controls power on/off or playback and pause. Rotating the second function button 502 adjusts the vibration intensity of the first vibrator 5 and the second vibrator 6, while pressing the second function button 502 switches input modes or toggles control between the two vibrators, enabling simultaneous control of both vibrators or selective control of one vibrator. The control panel 500 may further include additional function buttons or interfaces, which are not exhaustively illustrated here.

Referring to FIG. 7, in this example, the audio device 4 adopts an indirect arrangement relative to the side connecting member 32 to optimize comfort at the audio device 4 area of the headrest 3 during leaning. The headrest 3 further includes a pillow cushion 33 and a pillow cover 34. The pillow cushion 33 is filled with soft fillers such as down, cotton wool, or similar materials. Alternatively, the pillow cushion 33 may be made of foam. When foam is used, since the foam inherently maintains its shape, the outer surface of the foam may be wrapped with a fabric layer or left unwrapped. The audio device 4 is disposed on the pillow cushion 33, and the pillow cover 34 wraps the pillow cushion 33 around the central member 31 and the side connecting members 32, thereby indirectly arranging the audio device 4 on the side connecting members 32. In some implementations, the pillow cushion 33 adopts a sectioned design with independent small cushions to facilitate rotation of the side connecting members 32 and prevent bulging at bending areas. Specifically, the pillow cushion 33 includes one first cushion 331 and two second cushions 332 being independent of each other. The first cushion 331 is arranged corresponding to the central member 31, and the second cushions 332 are arranged corresponding to the side connecting members 32. Each second cushion 332 is provided with an accommodation groove 333, and the audio device 4 is embedded in the accommodation groove 333 while being spaced apart from the side connecting members 32. To facilitate sound transmission, when the pillow cover 34 is made of leather or other sound-insulating materials, multiple sound-transmitting holes may be formed in the pillow cover 34 at positions corresponding to the audio device 4. When the pillow cover 34 is made of fabric or other sound-permeable materials, the sound-transmitting holes may be omitted.

In other examples, the pillow cushion 33 may alternatively adopt an integrated design. In such cases, the pillow cushion 33 has an accommodation groove 333 at positions corresponding to the side connecting members 32. The audio device 4 is embedded in the accommodation groove 333 while being spaced apart from the side connecting members 32. To prevent bulging at bending areas of the pillow cushion 33, stitching lines may be added at the bending areas for localized compression.

In other examples, the audio device 4 may be fixedly secured to the side connecting members 32. For example, a mounting bracket may be provided on the side connecting member 32, and the audio device 4 is fixedly secured within the mounting bracket. Alternatively, a through groove may be formed in the side connecting member 32, and the audio device 4 is fixedly secured to the through groove.

Compared to the solution of directly fixedly securing the audio device 4 to the side connecting members 32, embedding the audio device 4 in the pillow cushion 33 may offer several benefits including: in the initial expanded state, when a seated user's head leans sideways against the position of the headrest 3 corresponding to the audio device 4, the pillow cushion 33 at this position is compressed under force, resulting in a relatively large compression stroke; in the rotationally folded state, when the side connecting members 32 drive the audio device 4 to rotate closer to the user's ears, the pillow cushion 33 at the audio device 4 position may not compress or may undergo relatively small compression depending on fitment. To control the immersive playback effect of the audio device 4, the distance between the audio device 4 and the front surface of the pillow cover 34 needs to be set relatively small. When adopting the solution of directly fixedly securing the audio device 4 to the side connecting members 32, the allowable compression stroke of the pillow cushion 33 at the audio device 4 position is smaller, causing a harder feel and a foreign object sensation at the audio device 4 position in the initial expanded state. In contrast, by embedding the audio device 4 in the pillow cushion 33, the distance between the audio device 4 and the front surface of the pillow cover 34 can be controlled to a relatively small value. Moreover, when the head contacts the audio device 4, the pillow cushion 33 can further compress to provide a buffer stroke, thereby ensuring a relatively soft feel at the audio device 4 position.

Referring to FIG. 7, this example provides a first installation structure of the audio device 4. Based on the aforementioned solution of embedding the audio device 4 in the pillow cushion 33, to facilitate installation and positioning of the audio device 4 within the pillow cushion 33, further and in some examples, the accommodation groove 333 is in a penetrating shape, and the thickness of the pillow cushion 33 is greater than the thickness of the audio device 4. Given the sectioned design of the pillow cushion 33 and the accommodation groove 333 being specifically formed in the second cushion 332, the thickness of the second cushion 332 is greater than that of the audio device 4. A first limiting member 41 is provided at a front end of the audio device 4, in some implementations, configured as an annular flange to ensure a rounded tactile feel. A second limiting member 42 is provided at a rear end of the audio device 4, in some examples, including multiple block-shaped structures locally protruding circumferentially on the audio device 4, with the multiple second limiting members 42 arranged circumferentially to save material and costs. The first limiting member 41 and the second limiting members 42 abut against edges of two openings of the accommodation groove 333, respectively. During installation, the audio device 4 is embedded in the accommodation groove 333, with both ends of the audio device 4 abutting against the edges of the accommodation groove 333. The audio device 4 locally compresses the pillow cushion 33 at the accommodation groove 333, utilizing the elasticity of the pillow cushion 33 to secure the audio device 4 in place and prevent displacement. This compression is bilateral, ensuring that a distance is reserved between the front end of the audio device 4 and the front surface of the pillow cover 34, as well as between the rear end of the audio device 4 and the surface of the side connecting member 32, thereby improving comfort at the audio device 4 area. In the rotationally folded state, the audio device 4 does not or minimally contacts the user, improving the conforming tactile experience. In the initial expanded state, after the seated user's head partially compresses the pillow cushion 33 and contacts the audio device 4, the remaining distance between the audio device 4 and the side connecting member 32 allows further compression of the pillow cushion 33, providing a dual-layer buffer effect. Additionally, the penetrating accommodation groove 333 facilitates wiring of the audio device 4. Correspondingly, the side connecting member 32 is provided with a wiring hole 321, enabling the wires of the audio device 4 to pass through the wiring hole 321 into the interior of the backrest 2 for concealed routing.

Referring to FIG. 8, this embodiment discloses a second installation structure of the audio device 4. Based on the aforementioned solution of embedding the audio device 4 in the pillow cushion 33 and the sectioned design of the pillow cushion 33, in this embodiment, the thickness of the pillow cushion 33 is greater than that of the audio device 4, and a portion of the second cushion 332 is laid in the spacing between the audio device 4 and the side connecting member 32. In this case, the accommodation groove 333 may be penetrating, with an end near the side connecting member 32 constricted to allow the second cushion 332 to be laid between the audio device 4 and the side connecting member 32. Alternatively, the accommodation groove 333 may be open only in a direction away from the side connecting member 32, with a reserved hole for wiring the audio device 4. In this embodiment, the audio device 4 is positioned in the accommodation groove 333 by elastic contraction of the second cushion 332 clamping the audio device 4 within the accommodation groove 333. In this embodiment, a first limiting member 41 is provided at the front end of the audio device 4, abutting against the edge of the front opening of the accommodation groove 333.

Referring to FIGS. 3, 5, and 6, the headrest 3 is detachably connected to the backrest 2 and fixedly secured. The backrest 2 includes a back frame 21, a back cushion 22, and a back cover 23. The back cover 23 partially wraps the back frame 21 to upholster the back frame 21. The back cushion 22 is installed on a front side of the back frame 21, and the headrest 3 is positioned above the back cushion 22. To facilitate convenient disassembly and reassembly of the headrest 3 for maintenance or replacement of the audio device 4 or entire headrest 3, in some examples, the back frame 21 is hollowed out at an upper rear side, and a horizontal plate 24 is provided at an upper front side of the back frame 21. The central member 31 is detachably connected to the horizontal plate 24. Specifically, a stud 311 is provided on the central member 31, and a through hole 241 is formed in the horizontal plate 24. The stud 311 passes through the through hole 241 from front to back and is connected to a nut 312. The back cover 23 includes a main fabric 231 and an openable rear fabric 232 located at the rear side of the back frame 21. At least a partial edge of the rear fabric 232 is detachably connected to the main fabric 231. When the rear fabric 232 is opened, the horizontal plate 24 is exposed.

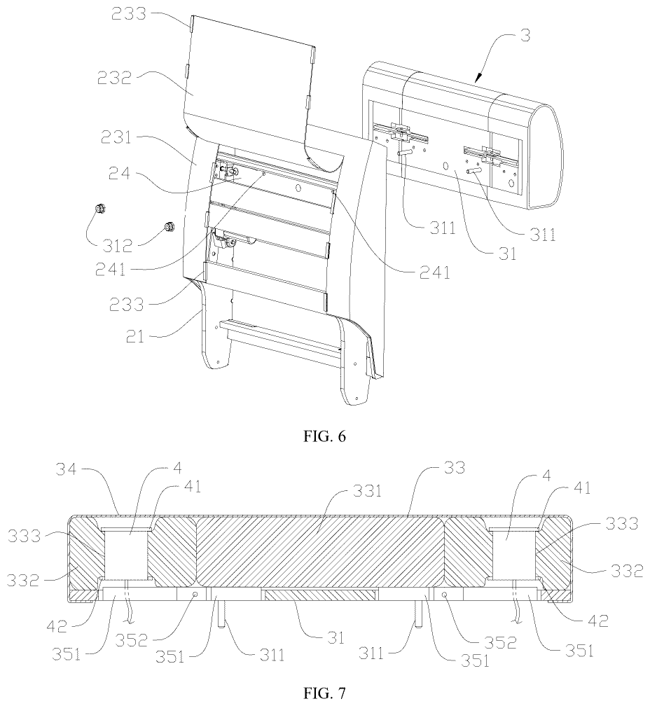

As a specific example, the connection between the rear fabric 232 and the main fabric 231 may be implemented as follows: The upper edge of the rear fabric 232 is integrally formed with or fixedly secured to the main fabric 231, while the left and right edges of the rear fabric 232 are detachably connected to the main fabric 231 via a zipper, clamping strip 233, hook-and-loop fastener, or similar detachable means. FIGS. 5 and 6 illustrate the connection using the clamping strip 233. To remove the headrest 3, detach the left and right edges of the rear fabric 232 from the main fabric 231, lift the rear fabric 232 upward to expose the hollowed space at the upper end of the back frame 21 and the horizontal plate 24, unscrew the nut 312 to disengage it from the stud 311, and finally pull the headrest 3 forward for removal.

It should be noted that the specific detachable connection structure between the central member 31 and the horizontal plate 24 may alternatively adopt a hook-and-screw fastening mechanism or similar designs, which are not exhaustively detailed here.

Referring to FIGS. 2 and 3, in this examples, since the headrest 3 is fixedly secured to the backrest 2, the tilt angle adjustment of the headrest 3 is achieved by hinging an upper portion of the back frame 21 to a lower portion of the back frame 21, with a linear actuator controlling the tilt angle of the upper portion of the back frame 21, thereby adjusting the tilt angle of the headrest 3. The solution of hinging the upper portion of the back frame 21 to the lower portion is prior art and thus not elaborated herein.

In other examples, the headrest 3 may alternatively be hinged to the backrest 2, allowing the headrest 3 to pivot forward or backward independently relative to the backrest 2 for tilt angle adjustment. The tilt angle control may similarly employ a linear actuator or adapt the aforementioned gear adjustment mechanism 353.

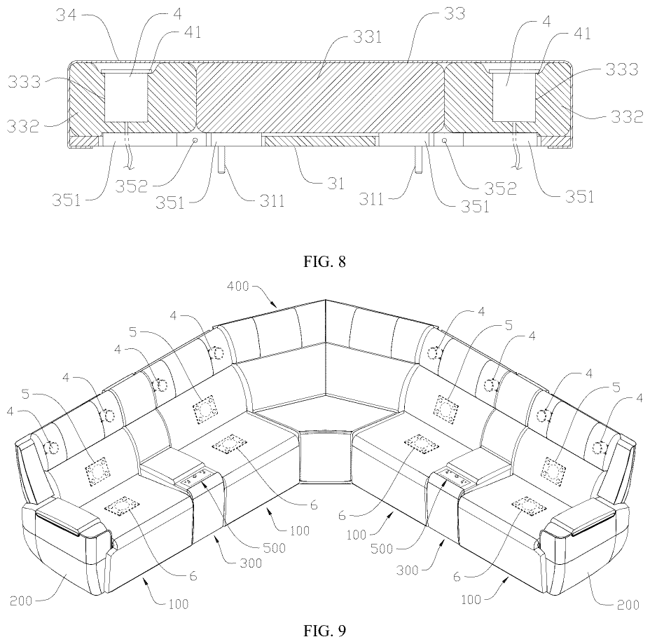

Referring to FIG. 9, the illustrated sofa is a corner sofa including four musical seat bodies 100, one corner seat body 400, two tea tables 300, and armrests 200 on both sides. One musical seat body 100 serves as a left-side seat sofa, another musical seat body 100 as a right-side seat sofa, another musical seat body 100 as a left-middle seat sofa, and another musical seat body 100 as a right-middle seat sofa. One tea table 300 is positioned between the left-side seat sofa and the left-middle seat sofa, and another tea table 300 between the right-side seat sofa and the right-middle seat sofa. In the corner sofa shown in FIG. 9, two control panels 500 are provided, each control panel 500 disposed on one tea table 300, and alternatively, the control panels 500 may be disposed on the armrests 200 depending on design requirements. Two control centers 700 are also provided, each control center 700 installed inside one tea table 300, one armrest 200, or one musical seat body 100.

Referring to FIG. 10, the illustrated sofa is also a corner sofa, including four musical seat bodies 100, one corner seat body 400, two tea tables 300, and armrests 200 on both sides. One musical seat body 100 serves as a left-side seat sofa, another as a right-side seat sofa, another as a left-middle seat sofa, and another as a right-middle seat sofa. One tea table 300 is positioned between the left-side seat sofa and the left-middle seat sofa, and another tea table 300 between the right-side seat sofa and the right-middle seat sofa. In contrast to FIG. 9, the corner sofa shown in FIG. 10 is provided with one control panel 500, which may be disposed on one of the tea tables 300, and alternatively, the control panel 500 may be disposed on one of the armrests 200 depending on design requirements. Two control centers 700 are provided, each installed inside one tea table 300, one armrest 200, or one musical seat body 100.

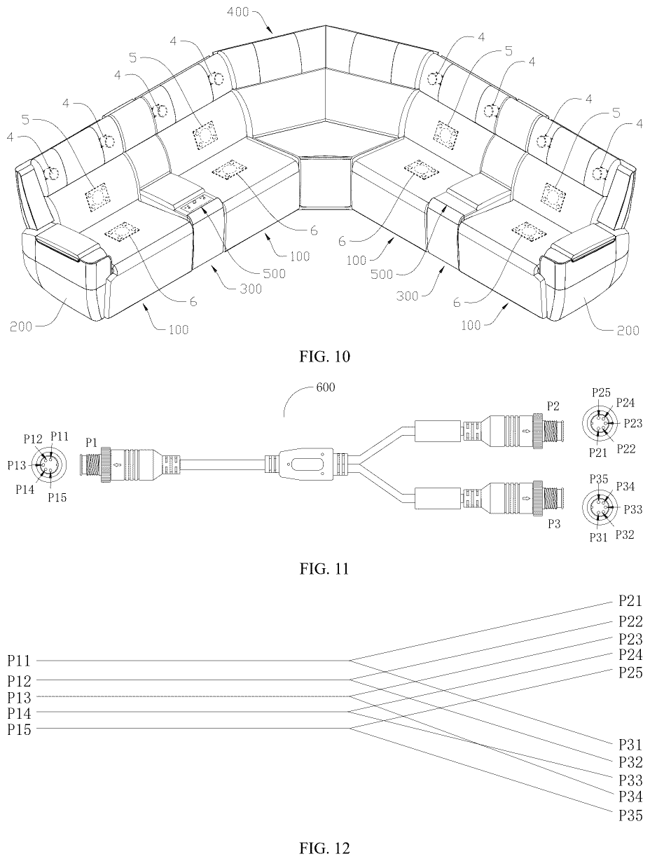

In the sofas illustrated in FIGS. 9 and 10, the two control centers 700 are interconnected via a Y-shaped connecting cable 600 included in the sofa. Specifically, the Y-shaped connecting cable 600 includes three interfaces, whose schematic diagram can be referred to in FIG. 11, which is a schematic structural diagram of the interface of the Y-shaped connecting cable according to the present disclosure. The interfaces of the Y-shaped connecting cable 600 are a first interface P1, a second interface P2, and a third interface P3. The wiring configurations between the first interface P1 and the second interface P2, as well as between the first interface P1 and the third interface P3, can be referred to in FIGS. 11-12. As shown in FIGS. 11-12, the connecting lines within the first interface P1 are P11-P15, those within the second interface P2 are P21-P25, and those within the third interface P3 are P31-P35. For the connection between the first interface P1 and the second interface P2, the connecting lines P11-P15 are respectively connected to P21-P25. For the connection between the first interface P1 and the third interface P3, the connecting lines P11-P12 and P15 are connected to P31-P32 and P35, while the connecting lines P13-P14 are cross-connected to P33-P34, i.e., P13 is cross-connected to P34, and P14 is cross-connected to P33. This wiring configuration creates a signal transmission difference between the first interface P1 and the second interface P2 compared to that between the first interface P1 and the third interface P3. This difference enables flexible selection and adjustment between a single-panel control mode and a dual-panel control mode, thereby achieving adaptable configuration of the control panels 500 for controlling the musical seat bodies 100. More specifically, the first interface P1 is electrically connected to one of the two control centers 700, while the second interface P2 and the third interface P3 are selectively connected to the other control center 700 of the two. For clarity, the control center 700 electrically connected to the first interface P1 is defined as the first control center, and the control center 700 connected to either the second interface P2 or the third interface P3 is defined as the second control center. The first control center is specifically the control center 700 connected to one of the control panels 500. By selectively connecting the second interface P2 or the third interface P3 to the second control center, different panel control modes between the musical seat bodies 100 controlled by the first control center and those controlled by the second control center can be achieved.

In some examples, the different panel control modes may include a single-panel control mode and a dual-panel control mode. In practical applications, the second interface P2 may be predefined to implement the single-panel control mode while the third interface P3 implements the dual-panel control mode, or vice versa. This example imposes no limitations on such predefined configurations.

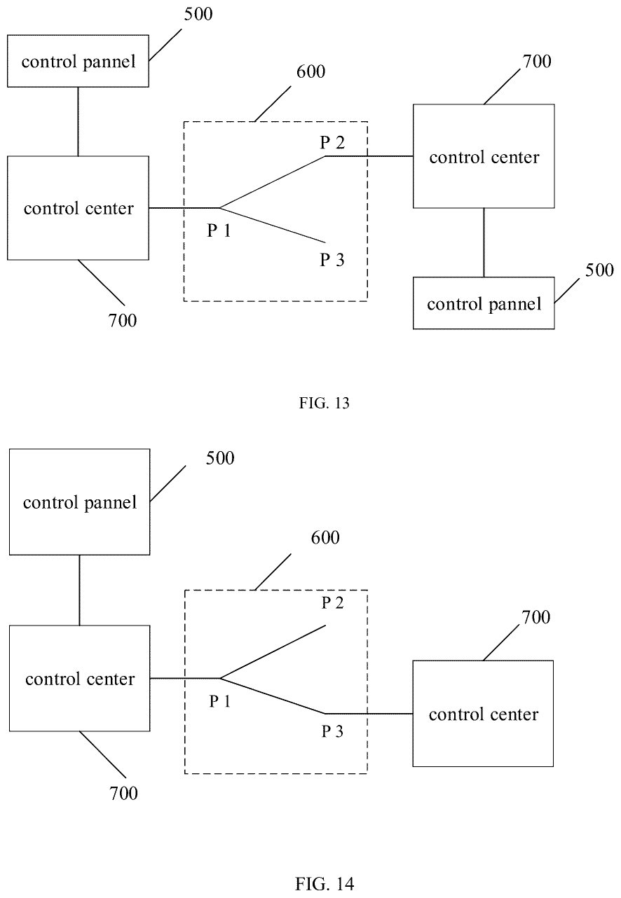

More specifically, the dual-panel control mode entails each control center 700 having a corresponding control panel 500. Different control panels 500 enable independent control of distinct musical seat bodies 100 or combinations thereof, enhancing flexibility in managing individual or grouped musical seat bodies 100. Alternatively, different control panels 500 may facilitate collaborative/synchronized control of multiple musical seat bodies 100 or combinations thereof, improving operational convenience for multi-seat coordination. Taking the sofa illustrated in FIG. 9 as an example, which has two distinct control panels 500, assume the second interface P2 is configured for the dual-panel control mode and the third interface P3 for the single-panel control mode. A schematic diagram of the dual-panel control mode principle is shown in FIG. 13, where the two control centers 700 are interconnected via the first interface P1 and the second interface P2. If a consumer wishes to remove the control panel corresponding to the control center 700 connected to the second interface P2, it is only necessary to reconnect the original control center 700 from the second interface P2 to the third interface P3. Further, in the dual-panel control mode, to enable independent control of different musical seat body 100 combinations: when the control center 700 connected to the second interface P2 receives a music control signal transmitted from the control center 700 connected to the first interface P1, it does not respond to the aforementioned signal. Conversely, if the control center 700 connected to the first interface P1 receives a music control signal from the control center 700 connected to the second interface P2, it similarly does not respond to the signal. To achieve collaborative control of different musical seat body 100 combinations, when the control center 700 connected to the second interface P2 receives a music playback control signal transmitted from the control center 700 connected to the first interface P1, the control center 700 connected to the second interface P2 responds to the aforementioned signal. Conversely, if the control center 700 connected to the first interface P1 receives a music playback control signal from the control center 700 connected to the second interface P2, the control center 700 connected to the first interface P1 responds to the signal.

More specifically, the single-panel control mode entails synchronously controlling the audio devices 4, first vibrators 5, and second vibrators 6 across multiple musical seat bodies 100 in the sofa via one control panel 500, improving control convenience and efficiency for multi-seat configurations. Taking the sofa illustrated in FIG. 10 as an example, which has only one control panel 500, assume the second interface P2 is configured for the dual-panel control mode and the third interface P3 for the single-panel control mode. A schematic diagram of the single-panel control mode principle is shown in FIG. 14, where the two control centers 700 are interconnected via the first interface P1 and the third interface P3. If consumers wish to add a control panel corresponding to the control center 700 connected to the third interface P3, it is only necessary to reconnect the original control center 700 from the third interface P3 to the second interface P2. Further, in the single-panel control mode, when the control center 700 connected to the third interface P3 receives a music control signal transmitted from the control center 700 connected to the first interface P1, the control center 700 connected to the third interface P3 responds to the aforementioned signal. Conversely, if the control center 700 connected to the first interface P1 receives a music playback control signal from the control center 700 connected to the third interface P3, the control center 700 connected to the first interface P1 responds to the signal.

Thus, this example enables flexible selection and adjustment between different panel control modes via the Y-shaped connecting cable 600, i.e., achieving adaptable configuration of the control panels 500 for controlling the musical seat bodies 100, thereby enhancing consumer's experience with the sofa.

It is specifically noted that FIGS. 13-14 schematically illustrate only the control centers 700, Y-shaped connecting cable 600, and control panels 500; other components including in the sofa are not shown in FIGS. 13-14.

To overcome at least one of the deficiencies described above, the present disclosure provides a sofa. The sofa arranges audio devices on the headrest with adjustable positions, which does not affect normal use of the sofa while providing an immersive music experience with relative high privacy.

The technical solutions adopted by the present application to address the problem are as follows:

A sofa includes at least one musical seat body, the musical seat body includes a sofa seat, a backrest, and a headrest, the backrest is connected to the sofa seat, in which the headrest includes a central member and two side connecting members, the central member is connected to the backrest, the two side connecting members are hinged to two opposite sides of the central member, each side connecting member is directly or indirectly provided with an audio device, and the side connecting members drive the audio devices to rotate relative to the central member to move the audio devices close to or away from a seated user's ears; the headrest has an initial expanded state and a rotationally folded state, in which in the initial expanded state, the side connecting members and the central member are relatively expanded to cause the headrest to be a flat-spread shape and position the audio devices away from the seated user's ears; and in the rotationally folded state, the side connecting members drive the audio devices to rotate inward relative to the central member to position the audio devices closer to the seated user's ears.

In some examples, the backrest is provided with a first vibrator corresponding to a seated user's back, the first vibrator being configured to provide vibration feedback when the audio device is playing music; and/or the sofa seat is provided with a second vibrator corresponding to a seated user's hips, the second vibrator being configured to provide vibration feedback when the audio device is playing music.

In some examples, at least one control panel and at least one control center, wherein the audio device, the first vibrator, and the second vibrator on the at least one musical seat body are electrically connected to one of the control centers and one of the control panels, the control panel being provided with a first function button and a second function button, the first function button being configured to adjust the audio device, and the second function button being configured to adjust at least one of the first vibrator and the second vibrator.

In some examples, the headrest further includes a pillow cushion and a pillow cover, the pillow cushion is provided with an accommodation groove at a position corresponding to the side connecting members, the audio device is embedded in the accommodation groove and spaced apart from the side connecting members, and the pillow cover wraps the pillow cushion around the central member and the side connecting members to indirectly arrange the audio device on the side connecting members.

In some examples, the pillow cushion includes one first cushion and two second cushions, the first cushion and the second cushions are independent of each other, the first cushion is arranged corresponding to the central member, the second cushions are arranged corresponding to the side connecting members, and the accommodation groove is provided on the second cushions.

In some examples, the accommodation groove is in a penetrating shape, a thickness of the pillow cushion is greater than that of the audio device, a front end of the audio device is provided with a first limiting member, a rear end of the audio device is provided with a second limiting member, and the first limiting member and the second limiting member abut against edges of two openings of the accommodation groove, respectively.

In some examples, the accommodation groove is at least open in a direction away from the side connecting members, the thickness of the pillow cushion is greater than that of the audio device, and a portion of the pillow cushion is laid in a spacing between the audio device and the side connecting members.

In some examples, the headrest is detachably connected to the backrest.

In some examples, the backrest includes a back frame and a back cover upholstered on the back frame, an upper rear side of the back frame is hollowed out, an upper front side of the back frame is provided with a horizontal plate, the central member is detachably connected to the horizontal plate, the back cover includes a main fabric and an openable rear fabric located at a rear side of the back frame, at least a partial edge of the rear fabric is detachably connected to the main fabric, and the horizontal plate is exposed when the rear fabric is opened.

In some examples, the central member is provided with a stud, the horizontal plate is provided with a through hole, and the stud passes through the through hole from front to back and is connected to a nut.

In some examples, the central member and the side connecting members are hinged through a hinge, the hinge includes two rotating arms, a rotating shaft, and a gear adjustment mechanism, an end of each of the two rotating arms is connected to the rotating shaft, the gear adjustment mechanism is arranged at the rotating shaft and is configured to adjust a relative angle between the two rotating arms and fix the angle, the central member and the side connecting members are plate-shaped, both the central member and the side connecting members are provided with interconnected avoidance grooves and connection grooves, the avoidance grooves correspond to the gear adjustment mechanism, and an opposite end of each of the rotating arms is inserted into the connection grooves and fixedly connected.

In some examples, the sofa includes at least two control centers and further includes a Y-shaped connecting cable;
the Y-shaped connecting cable includes a first interface, a second interface, and a third interface;
the first interface is configured to be electrically connected to one of the control centers, the second interface and the third interface are configured to be selectively connected to another control center, in which the control center electrically connected to the first interface is one of the control centers connected to the control panel;
when the second interface is electrically connected to another control center, the Y-shaped connecting cable is configured to implement a dual-control-panel mode; and when the third interface is electrically connected to another control center, the Y-shaped connecting cable is configured to implement a single-control-panel mode.

In summary, the sofa provided in the present disclosure delivers the following technical effects:

The headrest includes a central member and two side connecting members, where the central member is connected to the backrest, and the side connecting members are hinged to the central member. The audio devices are arranged on the side connecting members, enabling positional adjustment of the audio devices. When a seated user rests on the sofa, their head can lean against the central member of the headrest for physical relaxation. During music playback, the side connecting members can be rotated to bring the audio devices closer to the user's ears, providing an immersive music experience with enhanced sound quality and privacy. When immersive music playback is unnecessary, the audio devices can be moved away from the user's ears, allowing the user to freely adjust their posture—such as turning their head for conversation or leaning sideways for rest—without compromising normal use of the sofa. Other beneficial effects are demonstrated in the detailed embodiments.

The technical means disclosed in the solution of the present disclosure are not limited to those disclosed in the embodiments or examples mentioned above but also include technical solutions consisting of any combination of the above technical features. It should be noted that for those skilled in the art, multiple improvements and modifications may be made without departing from the principles of the present disclosure. These improvements and modifications are also considered to be within the scope of protection of the present disclosure.

What is claimed is:

1. A sofa, comprising:
at least one musical seat body, the musical seat body comprising a sofa seat, a backrest, and a headrest, wherein the backrest is connected to the sofa seat, wherein:
the headrest comprises a central member and two side connecting members, the central member is connected to the backrest, the two side connecting members are hinged to two opposite sides of the central member, each side connecting member is directly or indirectly provided with an audio device, and the side connecting members drive the audio devices to rotate relative to the central member to move the audio devices close to or away from a seated user's ears; and
the headrest has an initial expanded state and a rotationally folded state, wherein in the initial expanded state, the side connecting members and the central member are relatively expanded to cause the headrest to be a flat-spread shape and to position the audio devices away from the seated user's ears; and in the rotationally folded state, the side connecting members drive the audio devices to rotate inward relative to the central member to position the audio devices closer to the seated user's ears.

2. The sofa according to claim 1, wherein the backrest comprises a first vibrator corresponding to a seated user's back, the first vibrator is configured to provide vibration feedback when the audio device is playing music; or
wherein the sofa seat comprises a second vibrator corresponding to a seated user's hips, and the second vibrator is configured to provide vibration feedback when the audio device is playing music.

3. The sofa according to claim 2, further comprising at least one control panel and at least one control center, wherein the audio device, the first vibrator, and the second vibrator on the at least one musical seat body are electrically connected to one of the at least one control center and one of the at least one control panel, the control panel comprises a first function button and a second function button, the first function button is configured to adjust the audio device, and the second function button is configured to adjust at least one of the first vibrator or the second vibrator.

4. The sofa according to claim 1, wherein the headrest further comprises a pillow cushion and a pillow cover, the pillow cushion comprises an accommodation groove at a position corresponding to the side connecting members, the audio device is embedded in the accommodation groove and spaced apart from the side connecting members, and the pillow cover wraps the pillow cushion around the central member and the side connecting members to indirectly arrange the audio device on the side connecting members.

5. The sofa according to claim 4, wherein the pillow cushion comprises one first cushion and two second cushions, the first cushion and the second cushions are independent of each other, the first cushion is arranged corresponding to the central member, the second cushions are arranged corresponding to the side connecting members, and the accommodation groove is provided on the second cushions.

6. The sofa according to claim 4, wherein the accommodation groove is in a penetrating shape, a thickness of the pillow cushion is greater than that of the audio device, a front end of the audio device comprises a first limiting member, a rear end of the audio device comprises a second limiting member, and the first limiting member and the second limiting member abut against edges of two openings of the accommodation groove, respectively.

7. The sofa according to claim 4, wherein the accommodation groove is at least open in a direction away from the side connecting members, the thickness of the pillow cushion is greater than that of the audio device, and a portion of the pillow cushion is laid in a spacing between the audio device and the side connecting members.

8. The sofa according to claim 1, wherein the headrest is detachably connected to the backrest.

9. The sofa according to claim 8, wherein the backrest comprises a back frame and a back cover upholstered on the back frame, an upper rear side of the back frame is hollowed out, an upper front side of the back frame comprises a horizontal plate, the central member is detachably connected to the horizontal plate, the back cover comprises a main fabric and an openable rear fabric located at a rear side of the back frame, at least a partial edge of the rear fabric is detachably connected to the main fabric, and the horizontal plate is exposed when the rear fabric is opened.

10. The sofa according to claim 9, wherein the central member comprises a stud, the horizontal plate comprises a through hole, and the stud passes through the through hole from front to back and is connected to a nut.

11. The sofa according to claim 1, wherein the central member and the side connecting members are hinged through a hinge, the hinge comprises two rotating arms, a rotating shaft, and a gear adjustment mechanism, an end of each of the two rotating arms is connected to the rotating shaft, the gear adjustment mechanism is arranged at the rotating shaft and is configured to adjust a relative angle between the two rotating arms and fix the angle, the central member and the side connecting members are plate-shaped, both the central member and the side connecting members are provided with interconnected avoidance grooves and connection grooves, the avoidance grooves correspond to the gear adjustment mechanism, and an opposite end of each of the rotating arms is inserted into the connection grooves and fixedly connected.

12. The sofa according to claim 3, wherein the sofa comprises at least two control centers and further comprises a Y-shaped connecting cable;
the Y-shaped connecting cable comprises a first interface, a second interface, and a third interface;
the first interface is configured to be electrically connected to one of the control centers, the second interface and the third interface are configured to be selectively connected to another control center, wherein the control center electrically connected to the first interface is one of the control centers connected to the control panel;
when the second interface is electrically connected to another control center, the Y-shaped connecting cable is configured to implement a dual-control-panel mode; and when the third interface is electrically connected to another control center, the Y-shaped connecting cable is configured to implement a single-control-panel mode.

13. A musical seat body, comprising
a sofa seat, a backrest, and a headrest,
wherein the backrest is connected to the sofa seat,
wherein the headrest comprises a central member and two side connecting members, the central member is connected to the backrest, the two side connecting members are hinged to two opposite sides of the central member, each side connecting member is directly or indirectly provided with an audio device, and the side connecting members drive the audio devices to rotate relative to the central member to move the audio devices close to or away from a seated user's ears; and
wherein the headrest has an initial expanded state and a rotationally folded state, wherein in the initial expanded state, the side connecting members and the central member are relatively expanded to cause the headrest to be a flat-spread shape and to position the audio devices away from the seated user's ears; and in the rotationally folded state, the side connecting members drive the audio devices to rotate inward relative to the central member to position the audio devices closer to the seated user's ears.

14. The musical seat body according to claim 13, wherein the backrest comprises a first vibrator corresponding to a seated user's back, the first vibrator is configured to provide vibration feedback when the audio device is playing music; or
wherein the sofa seat comprises a second vibrator corresponding to a seated user's hips, and the second vibrator is configured to provide vibration feedback when the audio device is playing music.

15. The musical seat body according to claim 13, wherein the headrest further comprises a pillow cushion and a pillow cover, the pillow cushion comprises an accommodation groove at a position corresponding to the side connecting members, the audio device is embedded in the accommodation groove and spaced apart from the side connecting members, and the pillow cover wraps the pillow cushion around the central member and the side connecting members to indirectly arrange the audio device on the side connecting members.

16. The musical seat body according to claim 15, wherein the pillow cushion comprises one first cushion and two second cushions, the first cushion and the second cushions are independent of each other, the first cushion is arranged corresponding to the central member, the second cushions are arranged corresponding to the side connecting members, and the accommodation groove is provided on the second cushions.

17. The musical seat body according to claim 15, wherein the accommodation groove is in a penetrating shape, a thickness of the pillow cushion is greater than that of the audio device, a front end of the audio device comprises a first limiting member, a rear end of the audio device comprises a second limiting member, and the first limiting member and the second limiting member abut against edges of two openings of the accommodation groove, respectively.

18. The musical seat body according to claim 15, wherein the accommodation groove is at least open in a direction away from the side connecting members, the thickness of the pillow cushion is greater than that of the audio device, and a portion of the pillow cushion is laid in a spacing between the audio device and the side connecting members.

19. The musical seat body according to claim 13, wherein the headrest is detachably connected to the backrest.

20. The musical seat body according to claim 19, wherein the backrest comprises a back frame and a back cover upholstered on the back frame, an upper rear side of the back frame is hollowed out, an upper front side of the back frame comprises a horizontal plate, the central member is detachably connected to the horizontal plate, the back cover comprises a main fabric and an openable rear fabric located at a rear side of the back frame, at least a partial edge of the rear fabric is detachably connected to the main fabric, and the horizontal plate is exposed when the rear fabric is opened.
